(19) United States
(12) Patent Application Publication
(10) Pub. No.: US 2003/0049022 A1
(43) Pub. Date: Mar. 13, 2003

(54) Optical disk reproducing system to reproduce still pictures and method of reproducing same

(75) Inventor: Tae-hee Lee, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/238,888

(22) Filed: Sep. 11, 2002

(30) Foreign Application Priority Data
Sep. 11, 2001 (KR) 2001-55918

(51) Int. Cl. H04N 5/781

(52) U.S. Cl. 386/126; 386/117

(57) ABSTRACT

An optical disk reproducing system in which a user can select a still picture contained in a DVD audio disk and a method of reproducing the still pictures. The method includes reproducing a disk and detecting information on the number of still pictures contained in the disk track, dividing one or more displays into a plurality of sections, the number of sections depending on the number of still pictures, scaling the still pictures in accordance with the sizes of the sections of the divided display and sequentially mapping the pictures to the divided display. If a particular display is selected from the mapped displays, the display is restored to a display having a predetermined resolution.

### CROSS-REFERENCE TO RELATED APPLICATIONS

This application claims the benefit of Korean Application No. 2001-55918, filed Sep. 11, 2001, in the Korean Industrial Property Office, the disclosure of which is incorporated herein by reference.

### BACKGROUND OF THE INVENTION

1. Field of the Invention

The present invention relates to an optical disk reproducing system, and more particularly, to a system to reproduce still pictures contained in a DVD audio disk and a method of reproducing the still pictures.

2. Description of the Related Art

In general, a DVD audio reproducer has been recognized as a next generation audio system due to its excellent audio characteristics. DVD audio disks reproduced by the DVD audio reproducer can contain high quality signals and about 20 still pictures per audio track using MPEG-1/2 video 1 frame coding (Intra Picture Coding).

Accordingly, the DVD audio reproducer can sequentially output still pictures contained in a disk. However, a disadvantage of the DVD audio reproducer is that a user must search through all of the still pictures contained in the disk, starting with a first picture, so that a still picture is reproduced in accordance with an input from a key unit. In addition, the user also must search through all of the still pictures in order to obtain information about how many still pictures are included in a particular track of a video.

### SUMMARY OF THE INVENTION

Accordingly, it is an object of the present invention to provide a method of reproducing high quality still pictures in an optical disk reproducing system in which information about the still pictures contained in each track of the DVD audio disk is processed and to display all of the still pictures on one or more displays for the user's selection.

It is another object of the present invention to provide a system to reproduce an optical disk employing a method of reproducing high quality still pictures.

Additional objects and advantages of the invention will be set forth in part in the description which follows and, in part, will be obvious from the description, or may be learned by practice of the invention.

The foregoing and other objects of the present invention are achieved by providing a method of reproducing still pictures contained in a plurality of disk tracks in an optical disk reproducing system. The method includes reproducing a disk; detecting information on a number of the still pictures contained in one of the disk tracks; dividing one or more displays into a plurality of sections, the number of sections depending on the number of the still pictures; scaling the still pictures in accordance with sizes of the sections of the divided display; sequentially mapping the still pictures to the divided display; and if a particular display is selected, restoring the selected display to a predetermined resolution.

The foregoing and other objects of the present invention are also achieved by providing an optical disk reproducing system for reproducing still pictures contained on each of a plurality of disk tracks, comprising; a video decoder decoding a still picture and a header read out of the disk; a scaler dividing a display into a predetermined number of sections according to the information on the number of still pictures and sequentially mapping the still pictures decoded in the video decoder into each section; and a control unit determining the number of still pictures from the header decoded in the video decoder, applying the information on the number of still pictures to the scaler, and highlighting the divided still pictures.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of an optical disk system to reproduce still pictures according to an embodiment of the present invention; and

FIG. 2 is a flow chart showing a method to reproduce still pictures in the optical disk reproducing system shown in FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

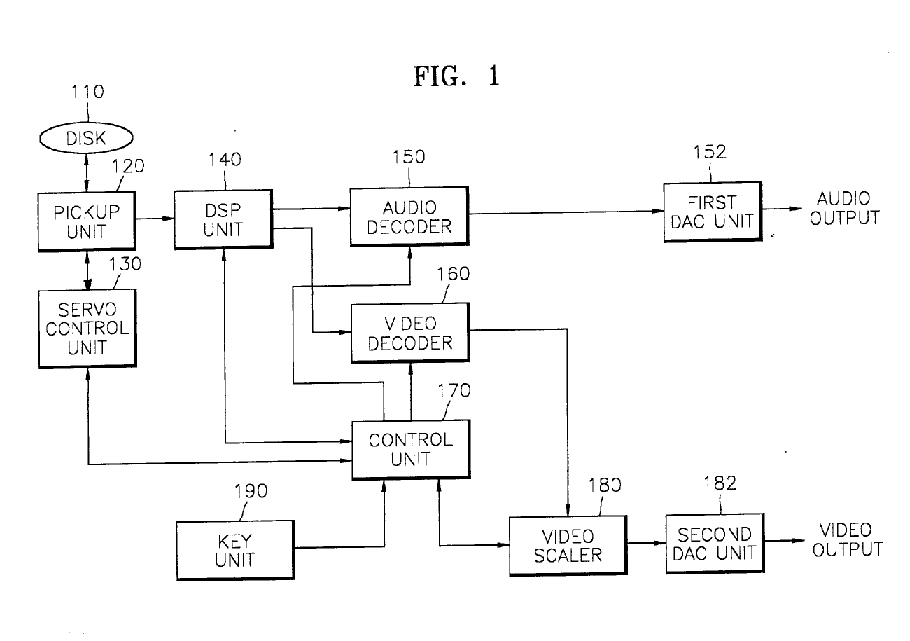

FIG. 1 is a block diagram of an optical disk system to reproduce still pictures according to an embodiment of the present invention.

Referring to FIG. 1, a pickup unit 120 reads data recorded on a disk 110, converts the data into EFM (eight to fourteen modulation) signals and generates servo signals to stabilize a servo (not shown) using the EFM signals. A DSP unit 140 demodulates the EFM signals output from the pickup unit 120 into original symbol data. A servo control unit 130 stabilizes the servo using the servo signals generated by the pickup unit 120.

An audio decoder unit 150 decodes only audio data from the symbol data output by the DSP unit 140. A first DAC unit 152 converts audio data received from the audio decoder unit 150 into an analog audio signal.

A video decoder unit 160 decodes headers related to the still pictures from the symbol data output by the DSP unit 140, stores the headers in an internal register and simultaneously decodes only still picture data.

A control unit 170 controls the entire system, extracts information about the headers related to the still pictures which are stored in the internal register and determines a number of the still pictures. The extraction of information can be performed by additional software and a device for this particular function. In addition, the control unit 170 highlights still pictures separated from a video scaler 180 in response to a key of a key unit 190, which is pressed by a user.

The video scaler 180 divides the display according to the number of still pictures determined by the control unit 170. The video scaler 180 sequentially scales the decoded still pictures in accordance with the sizes of sections of a display divided in the horizontal and vertical directions and maps the pictures into the sections of the divided display. In addition, if a still picture of the display out of the displays mapped by the key unit 190 is selected, the video scaler 180 restores the selected picture to its normal resolution.

A second DAC unit 182 converts the still picture data input from the video scaler 180 into an analog still picture.

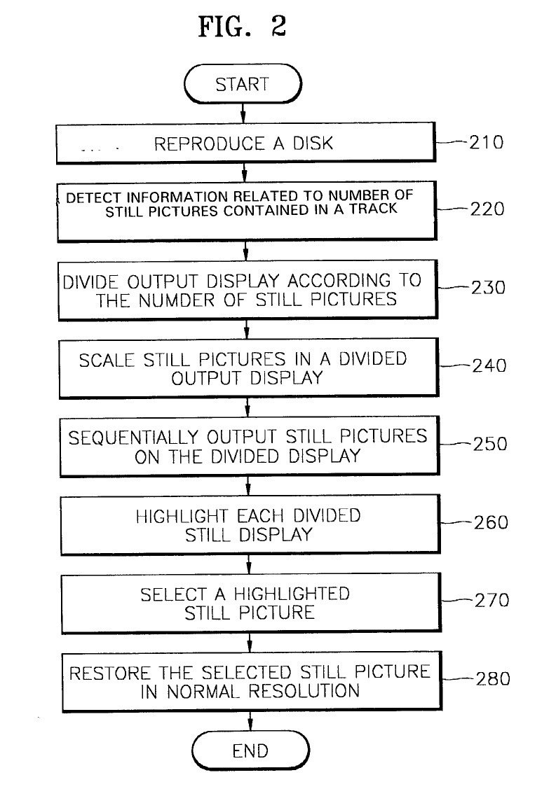

FIG. 2 is a flow chart of a method of reproducing still pictures in the optical disk reproducing system shown in FIG. 1. First, if a disk is reproduced (210), the information about the number of still pictures contained in the disk track to be reproduced is detected. (220) Next, the output display is divided into sections. The number of sections depends on the number of still pictures. (230) If the number of still pictures is too large to be output in a display, the still pictures are divided into a plurality of groups to prevent the resolution of the still pictures from being decreased. Then, after scaling the still pictures in accordance with the sizes of the sections (240), the still pictures are sequentially mapped into the sections of the divided displays. (250) Next, a user highlights a still picture of the divided display. (260) If the highlighted still picture is selected (270), the still picture is restored to its normal resolution. (280)

Although a few preferred embodiments of the present invention have been shown and described, it will be appreciated by those skilled in the art that changes may be made in these embodiments without departing from the principles and spirit of the invention, the scope of which is defined in the claims and their equivalents. For example, the present invention is not limited to the DVD audio disk and is applicable to all kinds of optical disks having tracks which can contain still pictures, such as CD-ROM, CD-graphic etc.

According to the embodiment of the present invention described above, it is possible to automatically process the information regarding the number of still pictures contained in each track of the DVD audio disk, etc., and display all of the still pictures on one or more displays. Therefore, the user can easily select or reproduce the pictures.

What is claimed is:

1. A method of reproducing still pictures contained in a plurality of disk tracks of a disk in an optical disk reproducing system, comprising:
reproducing data from the disk;
detecting information on a number of the still pictures contained in one of the disk tracks;
dividing one or more displays into a plurality of sections, the number of sections depending on the number of the still pictures;
scaling the still pictures in accordance with sizes of the sections of the divided display;
sequentially mapping the still pictures to the divided display; and
if a particular display is selected, restoring the selected display to a predetermined resolution.

2. The method of claim 1, further comprising:
highlighting the selected display.

3. The method of claim 1, further comprising:
dividing the one or more displays into a same number of sections as the number of the still pictures based on the detected information on the number of the still pictures.

4. An optical disk reproducing system to reproduce still pictures contained in a plurality of disk tracks on a disk, comprising:
a video decoder to decode the still pictures and a corresponding header from the disk; and
a control unit to determine a number of the still pictures from the header; and
a scaler to divide a display into a number of sections according to the number of the still pictures and to sequentially map the still pictures decoded in the video decoder into each section;
wherein the control unit further sends information on the number of the still pictures to the scaler, and highlights the mapped still pictures.

5. A method of reproducing still pictures stored in a disk track of an optical disk, comprising:
providing a display to display the still pictures;
dividing the display into a plurality of sections corresponding to a number of the still pictures; and
mapping the still pictures to the divided display.

6. The method of claim 5, wherein the still pictures are simultaneously displayed on the divided display.

7. The method of claim 5, further comprising scaling the still pictures in accordance with sizes of the sections of the divided display.

8. The method of claim 7, further comprising:
selecting one of the still pictures; and
restoring the selected still picture to a normal resolution.

9. The method of claim 7, further comprising:
dividing the still pictures into a plurality of groups if the number of the still pictures is too large to be output in the display.

10. The method of claim 5, further comprising:
dividing the still pictures into a plurality of groups if the number of the still pictures is too large to be output in the display, to prevent a resolution of the still pictures from being decreased below a predetermined resolution.

11. An optical disk reproducing system to reproduce still pictures stored in a disk track of an optical disk, comprising:
a display to display the still pictures;
a control unit to determine a number of the still pictures; and
a scaler to divide the display into a number of sections corresponding to the number of the still pictures and to sequentially map the still pictures to the divided display.

12. The optical disk reproducing system of claim 11, further comprising:
a video decoder to decode the still pictures and corresponding headers from the optical disk.

13. The optical disk reproducing system of claim 12, wherein the control unit further sends information on the number of the still pictures to the scaler.

14. The optical disk reproducing system of claim 13, further comprising:
a key unit to receive an input from a user,
wherein the control unit highlights a selected one of the still pictures based on the input from the user.

15. The optical disk reproducing system of claim 14, wherein the scaler restores the selected one of the still pictures to a normal resolution.

16. The optical disk reproducing system of claim 11, wherein the still pictures are simultaneously displayed on the divided display.
